(19) United States
(12) Patent Application Publication
(10) Pub. No.: US 2021/0229641 A1
(43) Pub. Date: Jul. 29, 2021

(54) DETERMINATION OF VEHICLE COLLISION POTENTIAL BASED ON INTERSECTION SCENE

(71) Applicant: GM Global Technology Operations LLC, Detroit, MI (US)

(72) Inventors: Shengbing Jiang, Rochester Hills, MI (US); Jiyu Zhang, Sterling Heights, MI (US); Mohamed A. Layouni, Warren, MI (US); Meng Jiang, Rochester Hills, MI (US); Jixin Wang, Northville, MI (US); Erik B. Golm, Warren, MI (US); Prakash Mohan Peranandam, Rochester Hills, MI (US)

(21) Appl. No.: 16/775,382

(22) Filed: Jan. 29, 2020

(51) Int. Cl. B60T 7/12; B60Q 9/00; G08G 1/056

(52) U.S. Cl. CPC B60T 7/12; G08G 1/056; B60Q 9/008

(57) ABSTRACT

Systems and methods of determining collision potential for a vehicle involve identifying a specific intersection that the vehicle is approaching, and determining an intention of a driver of the vehicle to traverse a specific path through the specific intersection. A method includes identifying an obstructed portion of a relevant area for the specific path of the vehicle through the specific intersection. An object travelling within the relevant area will intersect with the specific path of the vehicle and one or more sensors of the vehicle are blocked from detections in the obstructed portion of the relevant area. An alert is provided or actions are implemented based on the obstructed portion of the relevant area.

### INTRODUCTION

The subject disclosure relates to the determination of vehicle collision potential based on an intersection scene.

Vehicles (e.g., automobiles, trucks, construction equipment, farm equipment, automated factory equipment) increasingly employ sensors to obtain information about the vehicle and its environment. The sensor information facilitates augmentation or automation of vehicle operation. Exemplary sensors include a camera, a radio detection and ranging (radar) system, and a light detection and ranging (lidar) system. As a vehicle approaches an intersection with cross traffic, for example, information obtained using one or more sensors may facilitate an alert to the driver or autonomous maneuvers. However, the sensor information alone may not be entirely reliable. Accordingly, it is desirable to provide a determination of vehicle collision potential based on an intersection scene.

### SUMMARY

In one exemplary embodiment, a method of determining collision potential for a vehicle includes identifying, using a processor, a specific intersection that the vehicle is approaching, and determining, using the processor, an intention of a driver of the vehicle to traverse a specific path through the specific intersection. The method also includes identifying an obstructed portion of a relevant area for the specific path of the vehicle through the specific intersection. An object travelling within the relevant area will intersect with the specific path of the vehicle and one or more sensors of the vehicle are blocked from detections in the obstructed portion of the relevant area. An alert is provided or actions are implemented based on the obstructed portion of the relevant area.

In addition to one or more of the features described herein, the method also includes determining the relevant area for a plurality of paths through a plurality of intersections. The plurality of paths through the plurality of intersections include the specific path through the specific intersection.

In addition to one or more of the features described herein, the identifying the specific intersection that the vehicle is approaching includes obtaining a location of the vehicle and referencing the location of the vehicle on a map that identifies the plurality of intersections.

In addition to one or more of the features described herein, the determining the intention of the driver of the vehicle includes obtaining a button or turn signal input of the driver.

In addition to one or more of the features described herein, the determining the intention of the driver of the vehicle includes obtaining a location of the vehicle relative to routing information being provided to the driver.

In addition to one or more of the features described herein, the method also includes continuously updating the obstructed portion of the relevant area using the detections of the one or more sensors.

In addition to one or more of the features described herein, the method also includes recording an entry of an object into the obstructed portion of the relevant area using the one or more sensors.

In addition to one or more of the features described herein, the method also includes labeling the object as a hidden object based on the one or more sensors not detecting an exit of the object from the obstructed portion of the relevant area.

In addition to one or more of the features described herein, the providing the alert includes indicating a presence of the hidden object.

In addition to one or more of the features described herein, the implementing the actions includes automatic braking.

In another exemplary embodiment, a system to determine collision potential for a vehicle includes one or more sensors of the vehicle configured to detect areas outside the vehicle, and a processor to identify a specific intersection that the vehicle is approaching. The processor also determines an intention of a driver of the vehicle to traverse a specific path through the specific intersection, and identifies an obstructed portion of a relevant area for the specific path of the vehicle through the specific intersection. An object travelling within the relevant area will intersect with the specific path of the vehicle and one or more sensors of the vehicle are blocked from detections in the obstructed portion of the relevant area. The processor also provides an alert or to implement actions based on the obstructed portion of the relevant area.

In addition to one or more of the features described herein, the processor determines the relevant area for a plurality of paths through a plurality of intersections, and the plurality of paths through the plurality of intersections include the specific path through the specific intersection.

In addition to one or more of the features described herein, the processor identifies the specific intersection that the vehicle is approaching by obtaining a location of the vehicle and referencing the location of the vehicle on a map that identifies the plurality of intersections.

In addition to one or more of the features described herein, the processor determines the intention of the driver of the vehicle by obtaining a button or turn signal input of the driver.

In addition to one or more of the features described herein, the processor determines the intention of the driver of the vehicle by obtaining a location of the vehicle relative to routing information being provided to the driver.

In addition to one or more of the features described herein, the processor continuously updates the obstructed portion of the relevant area using the detections of the one or more sensors.

In addition to one or more of the features described herein, the processor also records an entry of an object into the obstructed portion of the relevant area using the one or more sensors.

In addition to one or more of the features described herein, the processor also labels the object as a hidden object based on the one or more sensors not detecting an exit of the object from the obstructed portion of the relevant area.

In addition to one or more of the features described herein, the alert includes an indication of a presence of the hidden object.

In addition to one or more of the features described herein, the actions include automatic braking.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a vehicle that performs determination of vehicle collision potential based on an intersection scene according to one or more embodiments;

FIG. 2 is an exemplary scenario illustrating the determination of vehicle collision potential based on an intersection scene according to one or more embodiments;

FIGS. 3A, 3B, and 3C depict additional exemplary scenarios illustrating the determination of vehicle collision potential based on intersection scenes according to one or more embodiments; and

FIG. 4 is a process flow of a method of performing determination of vehicle collision potential based on an intersection scene according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, vehicle sensors may provide information that facilitates an alert to the driver or autonomous action (e.g., automatic braking, collision avoidance) to avoid a potential collision. However, certain scenarios may render the sensors ineffective in conveying accurate information. Embodiments of the systems and methods detailed herein relate to a determination of vehicle collision potential based on an intersection scene. Hidden objects (e.g., other vehicles) that affect the reliability of sensor information are addressed according to one or more embodiments. Specifically, an upcoming intersection is examined for collision potential that may be obscured from the view of one or more sensors. Based on the intersection, what a sensor does not see may be relevant in determining that there is a potential for collision. The determination may lead to an alert for the driver or autonomous evasive actions.

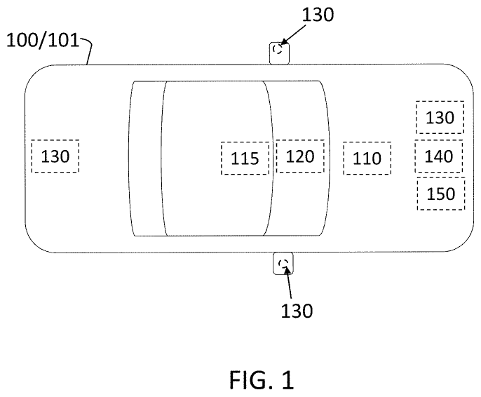

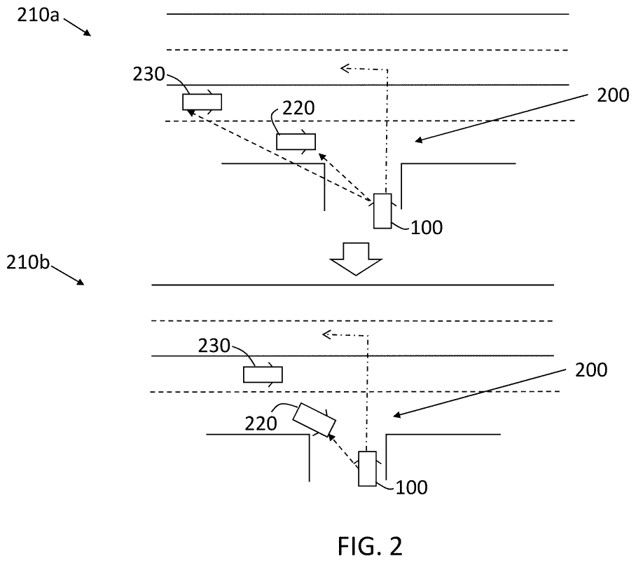

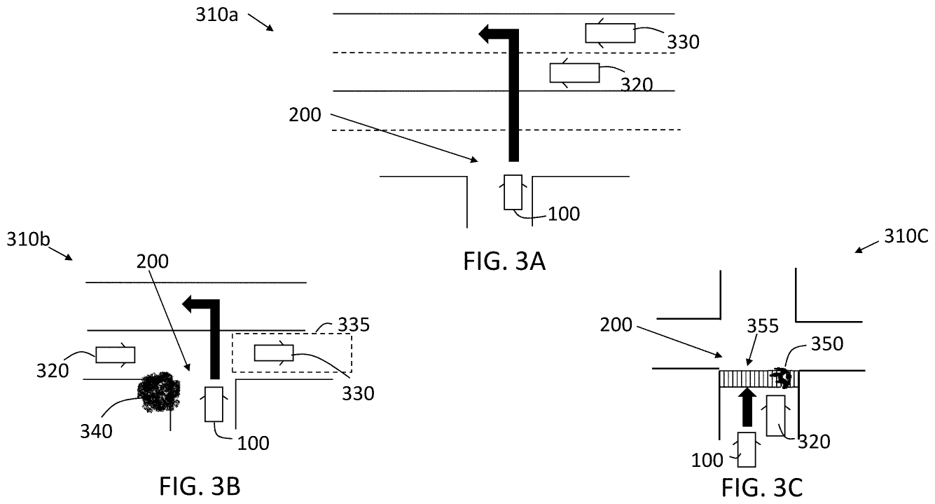

In accordance with an exemplary embodiment, FIG. 1 is a block diagram of a vehicle 100 that performs determination of vehicle collision potential based on an intersection scene 210 (FIG. 2), 310 (FIG. 3). The exemplary vehicle 100 shown in FIG. 1 is an automobile 101. The vehicle 100 includes a controller 110 that obtains information from sensors such as a lidar system 120, cameras 130, and a radar system 140. The controller 110 may also provide information through an infotainment system 115 or other interface with the driver of the vehicle 100. The vehicle 100 is shown with a global positioning system (GPS) 150 that provides the position of the vehicle 100 and, in conjunction with mapping information, may allow the controller 110 to determine upcoming intersections 200 (FIG. 2). The controller 110 may use the GPS 150 and map to provide routing information to the driver, for example. The exemplary numbers and locations of the sensors in FIG. 1 are not intended to limit alternate embodiments. The controller 110 may issue an alert or communicate with vehicle systems to perform automatic actions based on the determination of vehicle collision potential.

The controller 110 includes processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. As detailed with reference to FIGS. 2 and 3, determination of vehicle collision potential based on an intersection scene 210, 310 refers to considering the portions of an upcoming intersection 200 that are obscured from the view of any sensor of the vehicle 100.

FIG. 2 is an exemplary scenario illustrating the determination of vehicle collision potential based on an intersection scene 210 according to one or more embodiments. The intersection scenes 210a, 210b (generally referred to as 210) represent the state of intersection 200 at two time instants. The vehicle 100 is discussed with continuing reference to FIG. 1. Based on the position of the vehicle 100 and the other vehicles 220, 230 in the intersection scene 210a, a camera 130 of the vehicle 100 (e.g., the camera positioned at the left side mirror) detects both of the other vehicles 220, 230. As the relative positions of the vehicle 100 and the other vehicles 220, 230 change to those shown in the intersection scene 210b, one of the other vehicles 230 is obscured from the view of any of the sensors of the vehicle 100. Thus, determining collision potential based only on information detected by one or more sensors would be unreliable in the illustrated example.

According to one or more embodiments, the fact that an area behind the other vehicle 220 is obscured is taken into consideration when determining collision potential. This is true even if the other vehicle 230 were never in the view of the camera 130 of the vehicle 100. That is, if only the other vehicle 220 were ever detected, it is still true that an area behind that other vehicle 220 is obscured. This hidden area is taken into account in determining collision potential according to one or more embodiments. Other examples are discussed with reference to FIGS. 3A through 3C.

FIGS. 3A, 3B, and 3C (generally, FIG. 3) depict additional exemplary scenarios illustrating the determination of vehicle collision potential based on intersection scenes 310a, 310b, 310c (generally 310) according to one or more embodiments. FIG. 3A shows a vehicle 100 at the intersection 200 about to turn left. While one of the other vehicles 320 is visible and detectable by sensors (e.g., camera 130, lidar system 120, or radar system 140)), another of the other vehicles 330 is obscured. This hidden area is considered by the controller 110 in determining collision potential. Even if the other vehicle 330 had never been detected (unlike the other vehicle 230 in the intersection scene 210a), the intersection scene 310a is considered in identifying the hidden area and, thus, the collision potential.

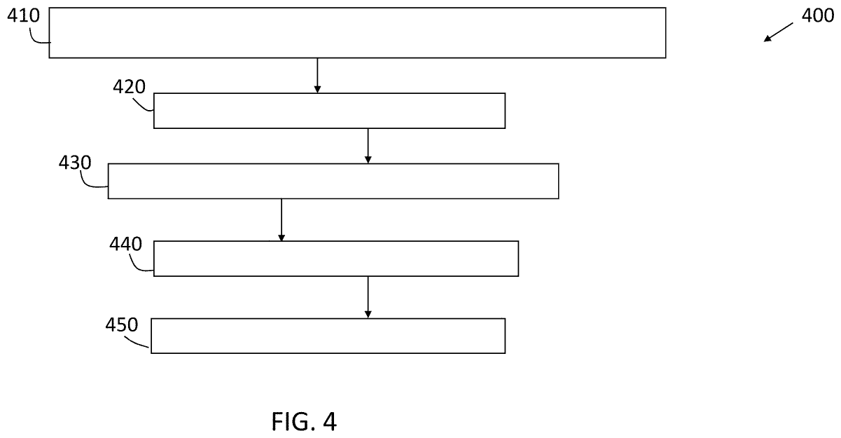

FIG. 3B shows intersection scene 310b. In the intersection scene 310b, a bush 340 obscures the view of the other vehicle 320 approaching the intersection 200 at which the vehicle 100 is stopped. The hidden area created by the bush 340 is considered in determining collision potential. In alternate embodiments, a building or other object may act as the obstruction rather than the bush 340. An area 335 that includes another vehicle 330 is also shown in FIG. 3B and is reference in the discussion of FIG. 4. FIG. 3C shows intersection scene 310c. In the intersection scene 310c, the pedestrian 350 is obscured from the view of the driver and sensors of the vehicle 100 by the other vehicle 320. Based on the map indicating a crosswalk 355, the hidden area created by the other vehicle 320 is identified, as is the resulting collision potential. In each of the exemplary cases, the GPS 150 identifies the relevant intersection 200 and available mapping information facilitates the identification of hidden areas that create the potential for collisions. As detailed with reference to FIG. 4, a more accurate assessment of collision potential also requires a determination of the driver's intention. For example, the fact that the other vehicle 330 is in a hidden area is not relevant in the intersection scene 310a if the vehicle 100 is turning right instead of left.

FIG. 4 is a process flow of a method 400 of performing determination of vehicle collision potential based on an intersection scene 210, 310 according to one or more embodiments. At block 410, identifying vehicle paths with collision potential for each intersection includes several processes and is implemented apriori for each known intersection. For example, map information may be used to identify a given intersection 200. The intersection 200 may be categorized according to type (e.g., a T-stop that with paths going either left or right only, an intersection 200 with a path only to the left, a four-way intersection 200 with paths going straight, left, or right). For a given type of intersection 200, different paths of the vehicle 100 have different collision potential. That is, for each path of the vehicle 100 through a given intersection, there may be a different relevant area of collision potential.

For example, for the intersection 200 shown in FIG. 3A, which is a T-stop, the collision potential is different based on whether the vehicle 100 is turning right or left. If the vehicle 100 is turning right, then only the view to the left of the vehicle 100 is relevant for collision avoidance (i.e., the relevant area to determine collision potential is the left side of the vehicle 100 in the lane in which the other vehicle 320 is travelling). If the vehicle 100 is turning left, as indicated in FIG. 3A, then the views to the left and to the right of the vehicle 100 are relevant and the hidden area in which the other vehicle 330 is travelling creates a collision potential. That is, the relevant area includes all four lanes shown in FIG. 3A and the left and right sides of the vehicle 100 in those lanes. By determining the collision potential paths for the vehicle 100 at different intersections 200 on the map ahead of time, that information may be used in real time as the GPS 150 indicates that the vehicle 100 is approaching one of those pre-considered intersections 200.

At block 420, determining the driver's intention in real time includes identifying the intersection 200 that the vehicle 100 is approaching. The intersection 200 may be identified using the GPS 150 indication of the location of the vehicle 100 in conjunction with a map. Determining driver intention may be based on a button or turn signal initiated by the driver as the vehicle 100 approaches a given intersection 200. The driver intention for the path through the intersection 200 may also be determined based on route navigation mapping initiated by the driver. This refers to the driver indicating a destination and getting a route map based on a combination of the GPS 150 and a mapping application (e.g., via the infotainment system 115 of the vehicle 100).

At block 430, identifying relevant obstructed views in real time accurately requires information about the upcoming intersection 200 (from block 410) and information about driver intention (from block 420). Specifically, as the vehicle 100 is approaching a given intersection 200, the collision potential for each path of the vehicle 100 through that intersection 200 (identified at block 410) is combined with the selected path according to the driver intention (identified at block 420) in order to determine the relevant area in real time.

For example, as previously noted, the area in which the other vehicles 320, 330 are traveling is only relevant for the path of a left turn for vehicle 100 in the intersection scene 310a (FIG. 3A). However, in the intersection scene 310b (FIG. 3B), the area in which the other vehicle 320 is travelling is relevant whether the vehicle 100 follows a right turn or a left turn path. Generally, the relevant area represents an area from which an object travelling legally could emerge and collide with the vehicle 100 (i.e., an object travelling within the relevant area will intersect with the path of the vehicle 100). Thus, the presence of the crosswalk 355 means that a pedestrian 350 could emerge into view of the vehicle in FIG. 3C. Also, the area 335 (in FIG. 3B) to the right of the vehicle 100 in the lane in which the other vehicle 320 is travelling is not a relevant area. This is because, according to the legal flow of traffic, as indicated in FIG. 3B, an object (e.g., another vehicle 330) in the same lane as the other vehicle 320 but that is to the right of the vehicle 100 would have already passed the vehicle 100 and could not emerge to potentially collide with the vehicle 100.

Once the relevant area that pertains to the real time scenario (i.e., according to the driver intention) is identified, an assessment is continuously made as to whether any part of that relevant area is obscured from sensor view. Stationary obstructions, as well as the behavior of other moving objects, are relevant to this assessment. For example, in the case of the intersection scene 310b, a portion of the relevant area for either a right turn or a left turn is always obstructed by the bush 340. In the exemplary case of the intersection scene 310a, the portion of the relevant area with the other vehicle 330 is only obstructed when another vehicle 320 is also present. If, as in the examples, any portion of the relevant area is obstructed, there is a collision potential.

At block 440, a determination is made of whether the collision potential (determined at block 430) is heightened. The likelihood of a potential collision may be estimated according to the processes at block 440 by identifying any previously visible objects. This refers to the scenario discussed with reference to FIG. 2, for example. When a previously visible object (e.g., the other vehicle 230) enters the portion identified as obstructed (at block 430), this information is recorded by the controller 110. If this object does not leave the obstructed portion, then the object is a known hidden object in the obstructed portion of the relevant area. An estimated speed of this hidden object may be used to estimate the likelihood of vehicle 100 colliding with the hidden object at the intersection 200.

At block 450, providing an alert or implementing an action (alternately or additionally) refers to several processes. An alert may be issued as the vehicle 100 approaches an intersection 200 and, alternately or additionally, at the intersection 200. The alert may specify whether a hidden object (i.e., an object that was detected entering an obstructed portion but not detected leaving the obstructed portion) is present in the relevant area. Alternate or additional to the alerts, autonomous actions (e.g., automatic braking) may be implemented based on the identification of obstructed portions (at block 430) or hidden objects (at block 440).

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of determining collision potential for a vehicle, the method comprising:
identifying, using a processor, a specific intersection that the vehicle is approaching;
determining, using the processor, an intention of a driver of the vehicle to traverse a specific path through the specific intersection;
identifying an obstructed portion of a relevant area for the specific path of the vehicle through the specific intersection, wherein an object travelling within the relevant area will intersect with the specific path of the vehicle and one or more sensors of the vehicle are blocked from detections in the obstructed portion of the relevant area; and
providing an alert or implementing actions based on the obstructed portion of the relevant area.

2. The method according to claim 1, further comprising determining the relevant area for a plurality of paths through a plurality of intersections, wherein the plurality of paths through the plurality of intersections include the specific path through the specific intersection.

3. The method according to claim 2, wherein the identifying the specific intersection that the vehicle is approaching includes obtaining a location of the vehicle and referencing the location of the vehicle on a map that identifies the plurality of intersections.

4. The method according to claim 1, wherein the determining the intention of the driver of the vehicle includes obtaining a button or turn signal input of the driver.

5. The method according to claim 1, wherein the determining the intention of the driver of the vehicle includes obtaining a location of the vehicle relative to routing information being provided to the driver.

6. The method according to claim 1, further comprising continuously updating the obstructed portion of the relevant area using the detections of the one or more sensors.

7. The method according to claim 1, further comprising recording an entry of an object into the obstructed portion of the relevant area using the one or more sensors.

8. The method according to claim 7, further comprising labeling the object as a hidden object based on the one or more sensors not detecting an exit of the object from the obstructed portion of the relevant area.

9. The method according to claim 8, wherein the providing the alert includes indicating a presence of the hidden object.

10. The method according to claim 1, wherein the implementing the actions includes automatic braking.

11. A system to determine collision potential for a vehicle, the system comprising:
one or more sensors of the vehicle configured to detect areas outside the vehicle; and
a processor configured to identify a specific intersection that the vehicle is approaching, to determine an intention of a driver of the vehicle to traverse a specific path through the specific intersection, to identify an obstructed portion of a relevant area for the specific path of the vehicle through the specific intersection, wherein an object travelling within the relevant area will intersect with the specific path of the vehicle and one or more sensors of the vehicle are blocked from detections in the obstructed portion of the relevant area, and to provide an alert or to implement actions based on the obstructed portion of the relevant area.

12. The system according to claim 11, wherein the processor is configured to determine the relevant area for a plurality of paths through a plurality of intersections, and the plurality of paths through the plurality of intersections include the specific path through the specific intersection.

13. The system according to claim 12, wherein the processor is configured to identify the specific intersection that the vehicle is approaching by obtaining a location of the vehicle and referencing the location of the vehicle on a map that identifies the plurality of intersections.

14. The system according to claim 11, wherein the processor is configured to determine the intention of the driver of the vehicle by obtaining a button or turn signal input of the driver.

15. The system according to claim 11, wherein the processor is configured to determine the intention of the driver of the vehicle by obtaining a location of the vehicle relative to routing information being provided to the driver.

16. The system according to claim 11, wherein the processor is configured to continuously update the obstructed portion of the relevant area using the detections of the one or more sensors.

17. The system according to claim 11, wherein the processor is further configured to record an entry of an object into the obstructed portion of the relevant area using the one or more sensors.

18. The system according to claim 17, wherein the processor is further configured to label the object as a hidden object based on the one or more sensors not detecting an exit of the object from the obstructed portion of the relevant area.

19. The system according to claim 18, wherein the alert includes an indication of a presence of the hidden object.

20. The system according to claim 11, wherein the actions include automatic braking.
